(19) United States
(12) Patent Application Publication
(10) Pub. No.: US 2026/0242095 A1
(43) Pub. Date: Aug. 20, 2026

(54) TAGGED CONTAINER AND TAGGED PREFORM

(71) Applicant: NISSHA CO.,LTD., Kyoto (JP)

(72) Inventors: Fumiya AMARI, Nagano (JP); Tadanobu ATOBE, Nagano (JP); Chuzo TANIGUCHI, Kyoto (JP); Satoshi WADA, Kyoto (JP)

(73) Assignee: NISSHA CO.,LTD., Kyoto (JP)

(21) Appl. No.: 18/872,282

(22) PCT Filed: Apr. 11, 2023
(86) PCT No.: PCT/JP2023/014735

§ 371 Date: Dec. 6, 2024

(30) Foreign Application Priority Data
Jul. 8, 2022 (JP) 2022-110789

(51) Int. Cl. B65D 23/14; B29C 49/12; B29L 31/00; B65D 1/02

(52) U.S. Cl. CPC B65D 23/14; B65D 1/0215; B65D 1/023; B29C 49/12; B29C 2949/079; B29L 2031/7158

(57) ABSTRACT

In a tagged preform, a cylindrical body manufactured as a separate component is fitted and fixed into an outer peripheral surface of a mouth of a preform main body, and a tag is arranged between the mouth and the cylindrical body. A tagged container is obtained by performing biaxial stretch blow molding on a trunk and a bottom of the tagged preform. The cylindrical body and the mouth of the preform main body remain, without being subjected to biaxial stretch blow molding, as an outer-layer-side container mouth and an inner-layer-side container mouth of a container mouth of the tagged container. The tagged container, with the tag arranged between inner and outer layers of the layered-structure container mouth having a layered-structure, is obtained without reliance on insert molding.

### TECHNICAL FIELD

The disclosure relates to a tagged container made of synthetic resin in which a container mouth has a layered structure including an outer-layer-side container mouth and an inner-layer-side container mouth, and also to a tagged preform used in manufacturing the tagged container.

### RELATED ART

As bottomed tubular containers for filling beverages or any other liquids, there are known containers made of synthetic resin and having a layered structure. For example, by subjecting an outer layer preform which is an injection molded product of thermoplastic resin to biaxial stretch blow molding with an inner layer preform which is also an injection molded product of thermoplastic resin mounted coaxially therewith, a container having a layered structure integrating an inner layer and an outer layer can be obtained. As a container having a layered structure, there is known a tagged container in which an information carrying tag such as a decorative tag or an IC tag, or any other tag, is inserted between the inner layer and the outer layer.

The present inventors have proposed the following in Patent Document 1. In a container having a layered structure obtained by biaxial stretch blow molding of an inner layer preform and an outer layer preform that are coaxially combined, a tag is arranged between an inner layer and an outer layer in a container mouth that does not undergo biaxial stretch blow molding. Tagging using radio-frequency identification (RFID) is expected to be used in the future for product traceability, brand protection (authenticity), caching, and rationalization. Data can be managed on a cloud server.

On the other hand, as such a container having a two-layer or multi-layer layered structure, there is known a container in which only a container mouth has a two-layer or multi-layer layered structure to be imparted with durability, strength or the like required for the container mouth, while the other portions such as a container trunk and a container bottom remain a single-layer structure. Such a container has been proposed in Patent Documents 2 to 10. As described in these patent documents, conventionally, in order to form a mouth of a synthetic resin container into a two-layer structure, a cylindrical piece for forming an inner layer or outer layer of the mouth of the container is inserted into an injection mold, and a preform is injection molded, thereby integrating the cylindrical piece with a preform mouth.

### PRIOR-ART DOCUMENTS

### Patent Documents

Patent Document 1: Japanese U.S. Pat. No. 6,857,375

Patent Document 2: Japanese Utility Model Laid-open No. S58-177331

Patent Document 3: Japanese Utility Model Laid-open No. S58-177332

Patent Document 4: Japanese Utility Model Laid-open No. S58-177333

Patent Document 5: Japanese Examined Utility Model Laid-open No. S52-24197

Patent Document 6: Japanese Patent Laid-open No. H05-285943

Patent Document 7: Japanese Examined Patent Laid-Open No. H06-88318

Patent Document 8: Japanese Examined Patent Laid-Open No. H07-33054

Patent Document 9: Japanese Examined Patent Laid-Open No. S60-17693

Patent Document 10: Japanese Patent Laid-open No. S57-175553

### SUMMARY OF THE INVENTION

### Problems to Be Solved by the Invention

In the containers described in Patent Documents 2 to 8, before injection molding of a bottomed preform for biaxial stretch blow molding, a tubular piece is inserted into the mold, and the preform and the tubular piece are integrated by injection molding.

A resin material possessing the characteristics required for the container mouth is used, and the tubular piece and a preform injection molding material are integrated by adhesion in their contact region.

There is a problem that the injection mold for molding the tubular piece may become complex, such as having a protrusion for rotation stopping on the tubular piece or having a through hole for introducing injection molding resin from an inner surface to an outer surface of the tubular piece, leading to insufficient air venting in the mold and short shots (shape defects due to insufficient filling).

In the case of inserting a tubular piece of a screw shape that allows for mounting of a screw cap or the like into the injection mold, the shape of the injection mold may become complex so that the tubular piece can be positioned, thus placing a limitation on cycle time.

In the containers described in Patent Documents 9 and 10, in order to impart mechanical strength to the container mouth, a piece forming a container trunk and a screw member made of a different synthetic resin material or metal are integrated by insert molding, and biaxial stretch blow molding is performed.

These members are mounted with the screw member locked in a circumferential direction, thereby being fixed and prevented from idling. However, since no fixation is provided in an up-down direction, there is a problem that a gap may be formed between these members.

Here, even in a container having a two-layer or multi-layer layered structure in which only a container mouth is imparted with durability and strength required for the two-layer or multi-layer layered structure, it is conceivable to arrange a decorative label, an RFID tag, an IC tag, or any other tag. In this case, the layered structure of the container mouth is realized by performing injection molding of the preform with a tubular piece forming an outer layer of the container mouth inserted into the injection mold, as described above. In the case of manufacturing, by insert molding, a preform for manufacturing a container that includes a container mouth having a layered structure, it is difficult to arrange a tag between the layers of the container mouth where high pressure and high heat are applied during injection molding. As described above, in the case of manufacturing the preform including a mouth having a layered structure by insert molding, there are problems to be solved such as increased complexity of the injection mold.

In view of the points mentioned above, the disclosure provides a tagged preform with a tag appropriately arranged between an inner layer and an outer layer of a mouth having a layered structure without relying on insert molding, as well as a tagged container obtained by biaxial stretch blow molding of the tagged preform.

### Means for Solving the Problems

The disclosure provides a tagged preform used in manufacturing a tagged container in which a container mouth has a layered structure including an inner-layer-side container mouth and an outer-layer-side container mouth. The tagged preform includes: a preform main body, made of synthetic resin and having a bottom, a trunk of a tubular shape, and a mouth of a tubular shape; a tubular body, made of synthetic resin and fitted and fixed into an outer peripheral surface of the mouth in an up-down direction of the tagged preform; and a tag, arranged between the outer peripheral surface of the mouth and an inner peripheral surface of the tubular body. The bottom and the trunk are portions that undergo biaxial stretch blow molding and serve as a container bottom and a container trunk of the tagged container. The mouth is a portion that directly forms the inner-layer-side container mouth without undergoing biaxial stretch blow molding. The tubular body is a portion that directly forms the outer-layer-side container mouth without undergoing biaxial stretch blow molding.

The disclosure provides a tagged container manufactured by biaxial stretch blow molding of the tagged preform having the above configuration. The tagged container includes a container bottom, a container trunk of a tubular shape, and a container mouth of a tubular shape. The container mouth has a layered structure including an inner-layer-side container mouth and an outer-layer-side container mouth. The container bottom and the container trunk are portions obtained by biaxial stretch blow molding of the bottom and the trunk of the preform main body. The inner-layer-side container mouth is a portion where the mouth of the preform main body remains unchanged without undergoing biaxial stretch blow molding. The outer-layer-side container mouth is a portion where the tubular body remains unchanged without undergoing biaxial stretch blow molding. The tag is arranged between the inner-layer-side container mouth and the outer-layer-side container mouth.

In the tagged preform of the disclosure, the tubular body manufactured as a separate component is fitted and fixed into the outer peripheral surface of the mouth of the preform main body, and the tag is arranged between the mouth and the tubular body. By subjecting the trunk and the bottom of the tagged preform having this configuration to biaxial stretch blow molding, a tagged container is obtained. The tubular body and the mouth of the preform main body do not undergo biaxial stretch blow molding, and remain unchanged as an outer layer and an inner layer of the container mouth.

### Effects of the Invention

According to the disclosure, without relying on insert molding, a tagged container can be obtained having a configuration in which a tag is arranged between an inner layer and an outer layer of a container mouth having a layered structure. In the obtained tagged container, the tag can be appropriately arranged at the container mouth having a layered structure without suffering adverse effects such as damage or misalignment due to high temperature and high pressure during injection molding or biaxial stretch blow molding.

### BRIEF DESCRIPTION OF THE DRAWINGS

FIG. 1(A) is a side view of a tagged container, (B) is a plan view of the tagged container, (C) is a partial longitudinal cross-sectional view of a container mouth of the tagged container, and (D) is an enlarged partial cross-sectional view of the container mouth.

FIG. 2(A) is a side view of a tagged preform used in manufacturing the tagged container, and (B) is a longitudinal cross-sectional view of the tagged preform.

FIG. 3 is a longitudinal cross-sectional view of a preform main body.

FIG. 4(A) is a side view of a cylindrical body, (B) is a bottom view of the cylindrical body, and (C) is a longitudinal cross-sectional view of the cylindrical body.

FIG. 5 is an explanatory diagram showing an overview of a manufacturing procedure of the tagged container.

FIG. 6(A) is a side view of the tagged container according to Embodiment 2 of the disclosure, (B) is a longitudinal cross-sectional view of the tagged container, (C) is a top view showing a top surface of a mouth of the tagged container, and (D) is an enlarged partial cross-sectional view showing the mouth.

FIG. 7(A) is a side view of a tagged preform used in manufacturing the tagged container of FIG. 6, and (B) is a longitudinal cross-sectional view of the tagged preform.

FIG. 8 is an explanatory diagram showing an overview of a manufacturing procedure of the tagged container of FIG. 6.

FIG. 9(A) is a side view showing an example of the tagged container to which a plug for top surface sealing is attached, (B) is a longitudinal cross-sectional view of the example, and (C) is a longitudinal cross-sectional view of the plug for top surface sealing.

FIG. 10 is a partial half longitudinal cross-sectional view showing another example of the tagged container to which a plug for top surface sealing is attached.

### DESCRIPTION OF THE EMBODIMENTS

The following describes a tagged container according to an embodiment of the disclosure, a tagged preform used in manufacturing the tagged container, and a manufacturing procedure of the tagged container, with reference to the drawings.

### Embodiment 1

### (Tagged Container)

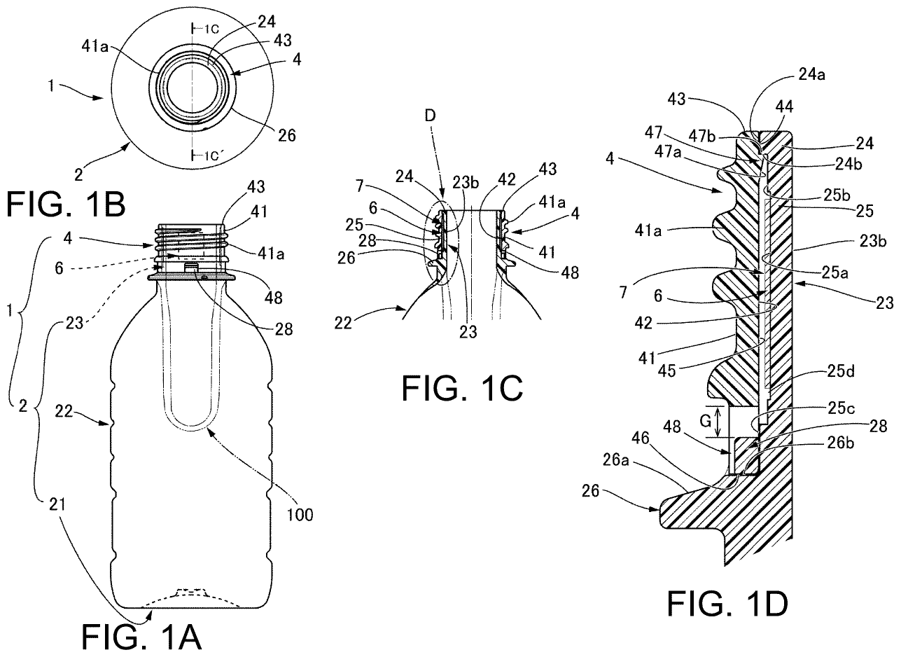

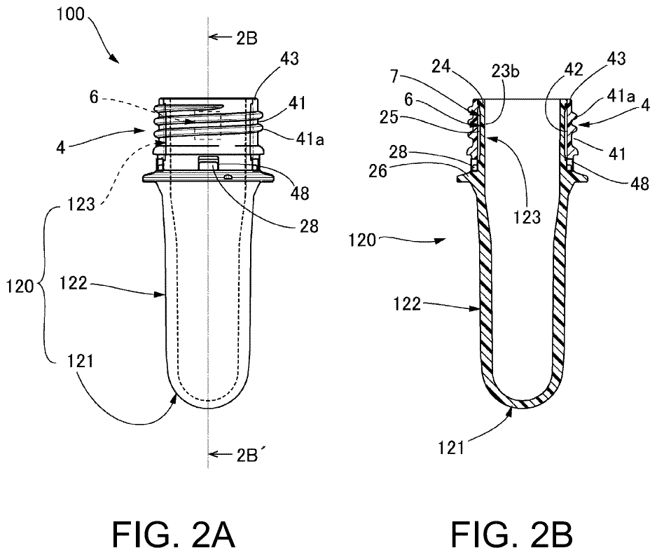

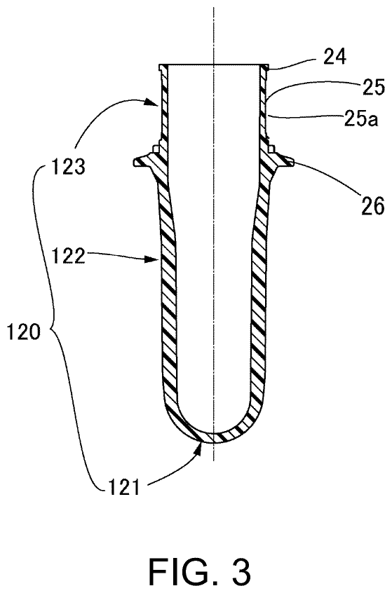

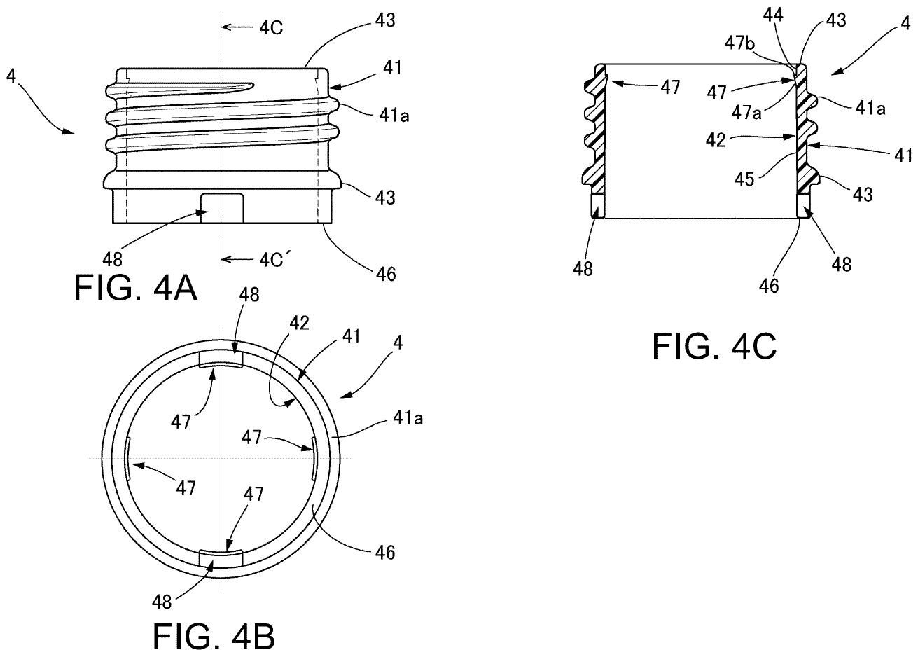

FIG. 1(A) is a side view of a tagged container, FIG. 1(B) is a top view showing an upper end face of a mouth of the tagged container, FIG. 1(C) is a partial longitudinal cross-sectional view showing a portion of the container mouth cut along line 1C-1C′, and FIG. 1(D) is an enlarged partial cross-sectional view of portion D of the container mouth. In a tagged container 1, a tag is arranged at a container mouth having a layered structure including an inner-layer-side container mouth and an outer-layer-side container mouth. The tagged container 1 includes: a container main body 2, made of synthetic resin and having a bottle shape; a tubular body (cylindrical body 4 in the present example), made of synthetic resin and for forming the outer-layer-side container mouth; and a tag 6. As described later, the tagged container 1 is obtained by biaxial stretch blow molding of a tagged preform 100 (see FIG. 2) which includes a preform main body (see FIG. 3), the cylindrical body 4 (see FIG. 4), and the tag 6. In the present example, the container main body 2 has a single-layer structure. However, the container main body 2 may have a two-layer or multi-layer layered structure in some cases.

The container main body 2 and the cylindrical body 4 are made from a thermoplastic resin material. As the thermoplastic resin material, PET (including crystalline, amorphous, and modified PET), PEF, PP, PEN, TPX, amorphous polyamide synthetic resin, PC, copolyester resin, plant-File: derived resin, biodegradable resin, recycled resin of the aforementioned resins, and blended resins can be used. Thermosetting resin can also be used as a material of the cylindrical body 4. It is possible that the container main body 2 and the cylindrical body 4 are made from the same type of resin or different types of resins.

The container main body 2 of the tagged container 1 is a biaxial stretch blow-molded product. As shown in FIG. 1(A) and FIG. 1(C), the container main body 2 includes a container bottom 21, a container trunk 22 of a cylindrical shape, and an inner-layer-side container mouth 23 of a thin cylindrical shape formed at an upper end of the container trunk 22. The container bottom 21 and the container trunk 22 are portions that have undergone biaxial stretch blow molding. The inner-layer-side container mouth 23 is a portion that has not undergone biaxial stretch blow molding. At an upper end of the inner-layer-side container mouth 23, an inner-layer-side mouth flange 24 of an annular shape is formed. At a lower end of the inner-layer-side mouth flange 24, an inner-layer-side mouth cylindrical part 25 is coaxially formed. On a lower side of the inner-layer-side mouth cylindrical part 25, a support ring 26 having a large diameter is coaxially formed. An upper end portion of the container trunk 22 is connected to a lower portion of the support ring 26.

An inner peripheral surface 23b of the inner-layer-side container mouth 23 has a constant inner diameter in an up-down direction. As shown in FIG. 1(D), on an outer peripheral surface of the inner-layer-side container mouth 23, from the upper side there are formed: a first outer peripheral surface 24a, which is an outer peripheral surface of the inner-layer-side mouth flange 24; a second outer peripheral surface 25a, which is an outer peripheral surface of the inner-layer-side mouth cylindrical part 25; and a third outer peripheral surface 26a, which is an outer peripheral surface of the support ring 26. A portion excluding a lower end portion of the second outer peripheral surface 25a is an outer peripheral surface portion 25b having a smaller diameter than the first outer peripheral surface 24a; the lower end portion is an outer peripheral surface portion 25c having the same outer diameter as the first outer peripheral surface 24a. A recess 25d for tag mounting is formed in the outer peripheral surface portion 25b. A mouth-side downward end face 24b of an annular shape is formed between the first outer peripheral surface 24a and the outer peripheral surface portion 25b on an upper end side of the second outer peripheral surface 25a. A mouth-side upward end face 26b of an annular shape is formed between the outer peripheral surface portion 25c on the lower end side of the second outer peripheral surface 25a and the third outer peripheral surface 26a on the lower side.

The cylindrical body 4 forming the outer-layer-side container mouth is shown in FIG. 4. FIG. 4(A), FIG. 4(B), and FIG. 4(C) respectively show a side view of the cylindrical body 4, a bottom view of the cylindrical body 4, and a longitudinal cross-sectional view of a portion of the cylindrical body 4 cut along line 4C-4C′. As shown in FIG. 1 and FIG. 4, a male screw 41a for mounting a screw cap (not shown) is formed on an outer peripheral surface 41 of the cylindrical body 4. In an inner peripheral surface 42 of the cylindrical body 4, a portion continuous with an upper opening end face 43 (top surface of cylindrical body) of the cylindrical body 4 is a first inner peripheral surface 44, and a portion from a lower side of the first inner peripheral surface 44 to a lower opening end face 46 is a second inner peripheral surface 45 having the same inner diameter as the first inner peripheral surface 44. An inward protrusion 47 is formed at an upper end portion of the second inner peripheral surface 45. The first outer peripheral surface 24a of the inner-layer-side container mouth 23 is coaxially fitted into the first inner peripheral surface 44. The second inner peripheral surface 45 is opposed to the second outer peripheral surface 25a of the inner-layer-side container mouth 23 with a predetermined gap, except for a lower end portion of the second outer peripheral surface 25a. Provided between the second inner peripheral surface 45 of the cylindrical body 4 and the recess 25d of the second outer peripheral surface 25a of the inner-layer-side container mouth is a tag arrangement gap 7 where the tag 6 is arranged.

The inward protrusion 47 is formed in multiple places at equal angular intervals in a circumferential direction at the upper end portion of the second inner peripheral surface 45. In the present example, as known from FIG. 4(B), the inward protrusion 47 is formed in four places at intervals of 90°. Each inward protrusion 47 has a constant width in the circumferential direction and includes a tapered arc surface 47a whose radially inward protrusion amount gradually increases upward. An upper end face of the inward protrusion 47 is a tubular body-side upward end face 47b of an arc shape having a constant width and in contact with the mouth-side downward end face 24b of the inner-layer-side container mouth 23 from below. The lower opening end face 46 of the cylindrical body 4 is a tubular body-side downward end face and is in contact with the mouth-side upward end face 26b on an upper surface side of the support ring 26 of the inner-layer-side container mouth 23 from above.

The cylindrical body 4 is in a state of being fitted and fixed between the mouth-side downward end face 24b of an annular shape and the mouth-side upward end face 26b of an annular shape of the inner-layer-side container mouth 23. By contacting the mouth-side downward end face 24b and the mouth-side upward end face 26b in the up-down direction, the cylindrical body 4 is attached to the inner-layer-side container mouth 23 in a state of being positioned in the up-down direction. Falling-out of the cylindrical body 4 with respect to the inner-layer-side container mouth 23 in the up-down direction can also be prevented.

Between the cylindrical body 4 and the inner-layer-side container mouth 23, a rotation stopper is arranged that prevents rotation of the cylindrical body 4 with respect to the inner-layer-side container mouth 23. The rotation stopper includes an engagement groove 48 formed on the cylindrical body 4 side and an engagement protrusion 28 formed on the inner-layer-side container mouth 23 side. The engagement groove 48 is a groove having a rectangular outline that opens at the lower opening end face 46 of the cylindrical body 4 and penetrates the cylindrical body 4 in the radial direction. In the present example, as known from FIG. 4, the engagement groove 48 is formed in two places separated by 180° in the circumferential direction. The engagement groove 48 is formed at positions corresponding to two inward protrusions 47 located at positions with an angular interval of 180° in the circumferential direction.

The engagement protrusion 28 on the inner-layer-side container mouth 23 side protrudes upward from the mouth-side upward end face 26b on the upper surface side of the support ring 26 that is in contact with the lower opening end face 46 of the cylindrical body 4. The engagement protrusion 28 is of a rectangular parallelepiped shape having a width dimension that allows fitting into the engagement groove 48 from below. The engagement protrusion 28 is arranged in two places with an angular interval of 180° in the circumferential direction, corresponding to the engagement groove 48. As shown in FIG. 1(D), in a state in which the engagement protrusion 28 is fitted into the engagement groove 48, a gap G having a predetermined width in the up-down direction is formed between an upper surface of the engagement protrusion 28 and a groove bottom surface of the engagement groove 48 opposed to the engagement protrusion 28 from above.

In a state in which the cylindrical body 4 is attached to the inner-layer-side container mouth 23, the engagement protrusion 28 of the inner-layer-side container mouth 23 is fitted into the engagement groove 48 of the cylindrical body 4 from below. Since the engagement protrusion 28 is engaged with the engagement groove 48 in the circumferential direction, misalignment of the cylindrical body 4 in the circumferential direction is prevented. When a force is applied that expands the gap G in the up-down direction and the cylindrical body 4 is forcibly pushed upward with respect to the inner-layer-side container mouth 23, an engaged portion between the inward protrusion 47 (tubular body-side upward end face 47b) and the mouth-side downward end face 24b can be plastically deformed or be damaged. Accordingly, it is possible to remove the cylindrical body 4 upward from the inner-layer-side container mouth 23.

As described above, the tag 6 is accommodated in the tag arrangement gap 7 formed between the second inner peripheral surface 45 of the cylindrical body 4 and the recess 25d of the second outer peripheral surface 25a of the inner-layer-side container mouth. In cases where a portion of the cylindrical body 4 or the inner-layer-side container mouth 23 is bent by an external force applied during biaxial stretch blow molding, filling, capping, or distribution, a dimension that can prevent damage to the tag 6 is necessary. For this purpose, it is desirable to set a gap dimension of the tag arrangement gap 7 to 0.1 mm to 5 mm. The tag 6 is, for example, a sheet-like RFID tag having a rectangular outline. The RFID tag has a configuration in which a flexible printed circuit board is mounted with a memory chip, an antenna pattern made of a conductive material such as copper foil, and so on.

The tag 6 is attached to the recess 25d formed in the second outer peripheral surface 25a of the inner-layer-side container mouth 23. The tag 6 may be attached to the second inner peripheral surface 45 of the cylindrical body 4 that defines the outer-layer-side container mouth. It is also possible to directly form wiring of an antenna pattern or the like on the second outer peripheral surface 25a of the inner-layer-side container mouth 23 by printing or the like, and then mount a memory chip or the like thereon.

In the container main body 2, a boundary between the inner-layer-side container mouth 23 that does not undergo biaxial stretch blow molding and an upper end of the container trunk 22 that undergoes biaxial stretch blow molding is not clearly defined. Stretch blow molding is performed in a state in which a stretch ratio gradually increases from a lower surface portion of the support ring 26 of the inner-layer-side container mouth 23 toward the container trunk 22. Generally, the inner-layer-side container mouth 23 where stretch blow molding is not performed refers to a portion from a top surface of a mouth of the container main body 2 to the vicinity of a lower surface of the support ring 26.

### Example of Tagged Preform

FIG. 2(A) is a side view showing a tagged preform used in manufacturing the tagged container 1, and FIG. 2(B) is a longitudinal cross-sectional view of a portion of the tagged preform cut along line 2B-2B′. FIG. 3 is a longitudinal cross-sectional view showing a preform main body. The tagged preform 100 will be described with reference to FIG. 2, FIG. 3, and FIG. 4.

The tagged preform 100 includes: a preform main body 120, which is an injection-molded product of thermoplastic resin; the cylindrical body 4, which is an injection-molded product of thermoplastic resin; and the tag 6. The preform main body 120 includes a bottom 121, a trunk 122 of a cylindrical shape, and a mouth 123 of a cylindrical shape formed at an upper end of the trunk 122. The preform main body 120 undergoes biaxial stretch blow molding and is molded into the container main body 2 of the tagged container 1. Specifically, the bottom 121 and the trunk 122 of the preform main body 120 are portions that undergo biaxial stretch blow molding and serve as the container bottom 21 and the container trunk 22 of the container main body 2. In contrast, the mouth 123 of the preform main body 120 is a portion that directly serves as the inner-layer-side container mouth 23 of the container mouth of the container main body 2 without undergoing biaxial stretch blow molding. The mouth 123 has the same structure as the inner-layer-side container mouth 23. The cylindrical body 4 is a portion that directly serves as the outer-layer-side container mouth of the container mouth without undergoing biaxial stretch blow molding.

In FIG. 2 and FIG. 3, the same reference numerals are assigned to portions of the mouth 123 of the preform main body 120 corresponding to each part of the inner-layer-side container mouth 23 of the container main body 2. The cylindrical body 4 is fitted and fixed into an outer peripheral surface of the mouth 123 of the preform main body 120 (from above in the present embodiment) in the up-down direction of the preform. The tag 6 is arranged between the outer peripheral surface of the mouth 123 and an inner peripheral surface of the cylindrical body 4. That is, the tag arrangement gap 7 is formed between the second outer peripheral surface 25a of the mouth 123 of the preform main body 120 and the inner peripheral surface 42 of the cylindrical body 4, and the tag 6 in a state of being attached to the second outer peripheral surface 25a is arranged in the tag arrangement gap 7.

The tubular body-side upward end face 47b of the four inward protrusions 47 located on an upper end side of the cylindrical body 4 contacts the mouth-side downward end face 24b of the inner-layer-side container mouth 23 from below, and the lower opening end face 46 of the cylindrical body 4 contacts the mouth-side upward end face 26b of the support ring 26 of the inner-layer-side container mouth 23 from above. Accordingly, the cylindrical body 4 is in a state of being fitted and fixed between the mouth-side downward end face 24b and the mouth-side upward end face 26b of the inner-layer-side container mouth 23. In the state in which the cylindrical body 4 is attached to the inner-layer-side container mouth 23, the engagement protrusion 28 of the inner-layer-side container mouth 23 is fitted into the engagement groove 48 of the cylindrical body 4. Since the engagement protrusion 28 is engaged with the engagement groove 48 in the circumferential direction, misalignment of the cylindrical body 4 in the circumferential direction is prevented.

### Example of Manufacturing Procedure of Tagged Container

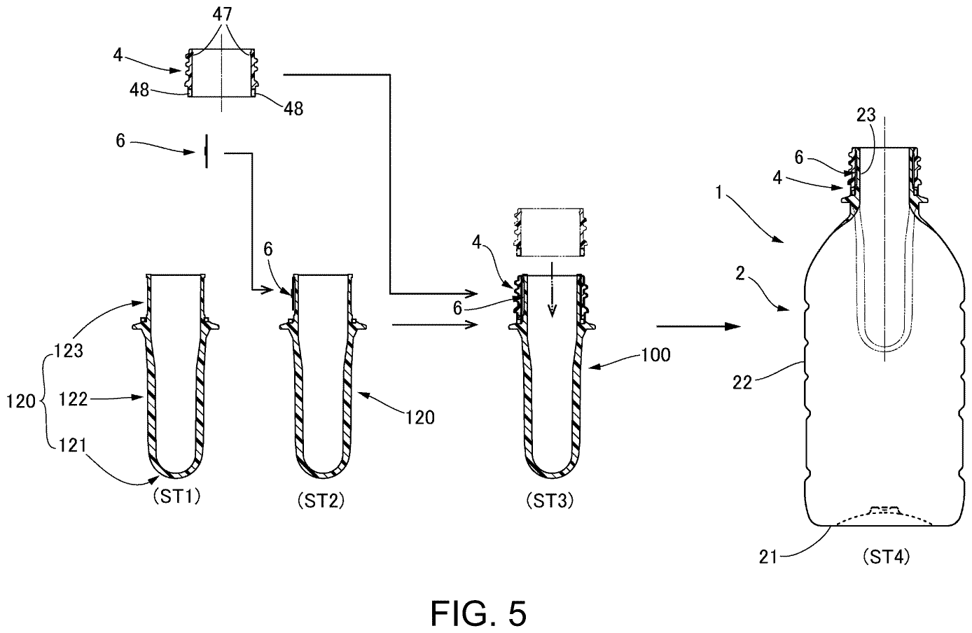

FIG. 5 is an explanatory diagram showing an overview of a manufacturing procedure of the tagged container 1. The preform main body 120 is prepared by injection molding using a thermoplastic resin material. Separately, the cylindrical body 4 that serves as the outer-layer-side container mouth is manufactured by injection molding using a thermoplastic resin material. The tag 6 is prepared (step ST1). The tag 6 is positioned and attached with an adhesive to the recess 25d of the second outer peripheral surface 25a of the mouth 123 of the preform main body 120 (step ST2).

Next, the cylindrical body 4 is attached to the preform main body 120 (step ST3). The cylindrical body 4 is positioned in the circumferential direction so that the engagement groove 48 and the engagement protrusion 28 that are both rotation stoppers coincide with each other. In this state, the mouth 123 of the preform main body 120 is coaxially inserted into the cylindrical body 4 from a lower end opening side. An inner diameter dimension of the cylindrical body 4 except for the portion of the inward protrusion 47 is set to a size that allows insertion of the mouth 123 of the preform main body 120. The cylindrical body 4 quickly moves until the mouth 123 of the preform main body 120 contacts the tapered arc surface 47a of the inward protrusion 47 of the cylindrical body 4. The tapered arc surface 47a gradually protrudes radially inward as going upward and defines an inner peripheral surface smaller than an outer diameter of the mouth. The inward protrusion 47 of the cylindrical body 4 is forcibly pushed along the first outer peripheral surface 24a of the inner-layer-side mouth flange 24 of the mouth 123. Accordingly, the inward protrusion 47 of the cylindrical body 4 climbs over the inner-layer-side mouth flange 24 of the preform main body 120 and is fitted into the lower side thereof. Meanwhile, the lower opening end face 46 of the cylindrical body 4 contacts the mouth-side upward end face 26b of the preform main body 120 from above. The engagement protrusion 28 for rotation stopping on the preform main body 120 side is fitted into the engagement groove 48 for rotation stopping of the cylindrical body 4 from below. As a result, the cylindrical body 4 is fitted and fixed into the second outer peripheral surface 25a of the mouth 123 in a state of being positioned in the up-down direction and the circumferential direction, and the tagged preform 100 is obtained including a mouth having a two-layer structure in which the tag 6 is arranged between the inner layer and the outer layer.

Next, the tagged preform 100 is heated to a temperature suitable for biaxial stretch blow molding. The tagged preform 100 after heating is placed into a blow molding mold (not shown), the mold is clamped, and biaxial stretch blow molding is performed (step ST4).

In this case, portions of the tagged preform 100 excluding the mouth 123 and the cylindrical body 4 are heated from the outside using a heater or the like. For example, the mouth 123 and the cylindrical body 4 of the tagged preform 100 are blocked from heat by being covered by a shielding plate or the like. The tag 6 arranged between these portions is not exposed to high temperatures and does not suffer damage such as thermal deformation. In the tagged preform 100, the trunk 122 and the bottom 121 are portions having a single-layer structure. Thus, unlike the case where a preform having a two-layer or multi-layer structure is heated, each part of the bottom 121 and the trunk 122 is uniformly heated, and a temperature state suitable for blow molding is efficiently achieved. The tagged preform 100 after heating is placed into the blow molding mold (not shown), the mold is clamped, and biaxial stretch blow molding is performed. Accordingly, the tagged preform 100 is molded into the tagged container 1.

In the tagged container 1, the container bottom 21 and the container trunk 22 are portions formed by biaxial stretch blow molding of the bottom 121 and the trunk 122 of the tagged preform 100. The inner-layer-side container mouth 23 to which the cylindrical body 4 is attached is a portion where the cylindrical body 4 and the mouth 123 of the tagged preform 100 remain unchanged. That is, the cylindrical body 4 and the mouth 123 of the tagged preform 100 are portions held by a portion of the blow molding mold (not shown), and remain in their original shape without undergoing stretch blow molding. Accordingly, the tag 6 arranged between the cylindrical body 4 and the mouth 123 is not exposed to high-pressure air and is not stretched. Accordingly, in a blow molding process, no adverse effects such as damage or disconnection occur in the tag 6. After blow molding, the tagged container 1 is taken out from the blow molding mold and is collected in a predetermined place.

In the tagged container 1, in order to increase bonding strength between the cylindrical body 4 and the inner-layer-side container mouth 23, an adhesive or a gluing agent may be applied between the cylindrical body 4 and the inner-layer-side container mouth 23. For example, before a cylindrical body attachment process (step ST3), an application process is performed in which a chemical agent such as an adhesive or a gluing agent is applied to an outer peripheral surface of the preform main body 120.

### Effects of Embodiment 1

The tagged container 1 configured as described above is provided, for example, in a state of being filled with contents such as beverages, cosmetics, or liquid medicines and being capped. The tag 6, which is arranged inside the container mouth having a layered structure (two-layer structure in the present example) composed of the inner-layer-side container mouth 23 and the cylindrical body 4 being the outer-layer-side container mouth, is capable of carrying various types of information such as information related to the contents or handling history. The carried information can be read and confirmed from the outside via wireless communication. If a rewritable RFID tag is used, the carried information can be updated or rewritten as needed. By utilizing a lock function for prohibiting rewriting of the carried information, the security of the carried information is ensured.

The tag 6 is arranged between the inner-layer-side container mouth 23 and the cylindrical body 4 that do not undergo biaxial stretch blow molding. Unlike the case where the cylindrical body 4 is integrated by insert molding and a container mouth having a layered structure is formed, the tag 6 is appropriately arranged between the layers of the container mouth having a layered structure, without suffering adverse effects such as damage or misalignment due to high temperature and high pressure during injection molding. Unlike the case where the tag 6 is arranged in the container trunk 22 or the container bottom 21, since there is no exposure to high heat, high pressure or stretching for biaxial stretch blow molding, adverse effects such as damage, deformation, or misalignment due to these factors do not occur. Accordingly, the tagged container 1 can be obtained in which the tag 6 is appropriately arranged between the layers of the container mouth.

If an information carrying tag such as an RFID tag is arranged on an outer peripheral surface of a container, there is a problem that mischief, tampering or the like is likely to occur. However, in the tagged container 1 of the present example, since the tag 6 is arranged between the layers (between cylindrical body 4 being outer-layer-side container mouth and inner-layer-side container mouth 23) of the container mouth having a two-layer structure, mischief, tampering or the like is less likely to occur. Furthermore, since the container mouth having a two-layer structure has higher rigidity and strength and is less likely to be deform compared to the container trunk 22 and the container bottom 21 having a single-layer structure, there is little risk of the container mouth being significantly deformed and the tag 6 being damaged. In addition, since the container mouth having a two-layer structure is covered by being mounted with a cap (not shown) and is protected and reinforced, the safety of the tag 6 arranged inside the container mouth is ensured.

Furthermore, in the present example, the cylindrical body 4 can be disassembled from the inner-layer-side container mouth 23. The gap G of a predetermined width in the up-down direction is formed between the engagement protrusion 28 for rotation stopping of the inner-layer-side container mouth 23 and a groove bottom surface of the engagement groove 48 for rotation stopping of the cylindrical body 4. For example, by inserting a tool into the gap G and expanding the gap G in the up-down direction, the cylindrical body 4 is forcibly pushed out upward. The inward protrusion 47 formed on the upper end side of the cylindrical body 4 and the mouth-side downward end face 24b of the inner-layer-side container mouth 23 are deformed, and the engaged portion therebetween is forcibly disengaged. Accordingly, the cylindrical body 4 comes off from the inner-layer-side container mouth 23 and can be removed upward. When a large force acts to forcibly deform and disengage the inward protrusion 47 and the mouth-side downward end face 24b, these portions are plastically deformed or damaged, making it impossible to re-engage the tubular body-side upward end face 47b of the inward protrusion 47 with the mouth-side downward end face 24b, thus disabling re-fitting of the cylindrical body 4. In this way, it is possible to provide an anti-counterfeiting function to the engaged portion between the tubular body-side upward end face 47b of the inward protrusion 47 and the mouth-side downward end face 24b so that re-engagement is disabled after disengagement.

By separating the cylindrical body 4 from the inner-layer-side container mouth 23 to which the tag 6 is attached, and removing the tag 6 from the outer peripheral surface of the inner-layer-side container mouth 23 after the cylindrical body 4 has been removed, the cylindrical body 4, the container main body 2 including the inner-layer-side container mouth 23, and the tag 6 can be separately collected, which is thus advantageous for reuse of materials of these components.

The gap G used when removing the cylindrical body 4 is generally in a state of being covered and protected by a pilfer-proof cap (PP cap) body that is screwed onto a neck screw portion, as typically seen in a PET beverage bottle, and a ring-shaped tamper-evident (TE) band connected to a lower end of a skirt portion of the cap body via a breakable bridge. When the bottle is opened, a perforation on a lower part of the cap is cut, indicating that it has been opened. Since the gap G is always protected by the TE band before and after opening the cap, “tamper prevention” is also ensured.

### Embodiment 2

Next, described is a tagged container according to Embodiment 2 to which the disclosure is applied, a tagged preform used in manufacturing the tagged container, and a manufacturing procedure of the tagged container.

### (Tagged Container)

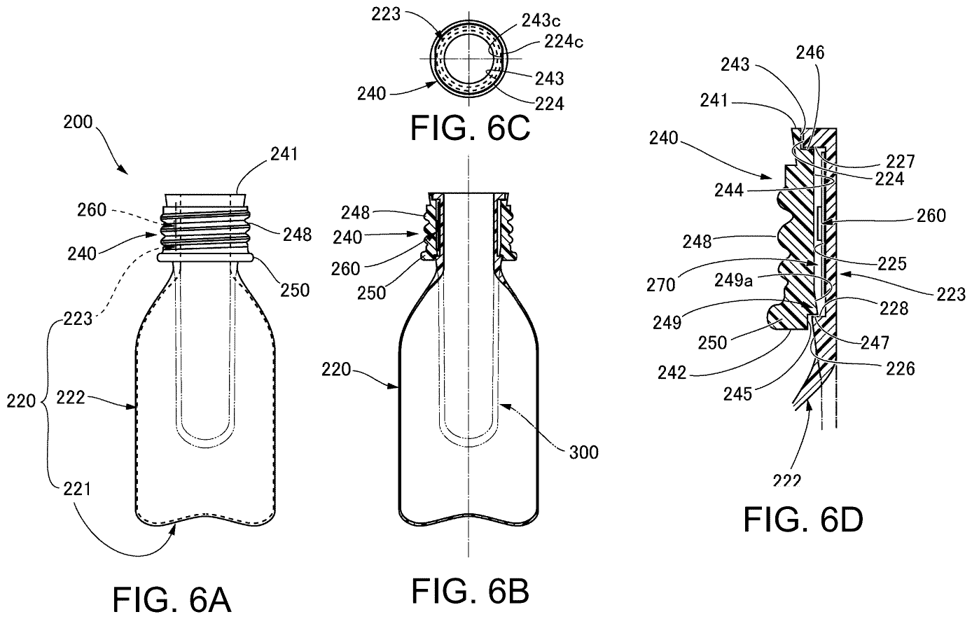

FIG. 6(A) is a side view of the tagged container, FIG. 6(B) is a longitudinal cross-sectional view of the tagged container, FIG. 6(C) is a top view showing a top surface of a mouth of the tagged container, and FIG. 6(D) is an enlarged partial cross-sectional view showing the mouth. Similarly to the case of Embodiment 1, in a tagged container 200, a tag is arranged at a container mouth having a layered structure including an inner-layer-side container mouth and an outer-layer-side container mouth. The tagged container 200 includes: a container main body 220 having a bottle shape, a cylindrical body 240 for forming the outer-layer-side container mouth, and a tag 260. The container main body 220 and the cylindrical body 240 are made from a thermoplastic resin material, and the same thermoplastic resin material as that in Embodiment 1 can be used.

The container main body 220 is a biaxial stretch blow-molded product, and includes a container bottom 221, a container trunk 222 of a cylindrical shape, and an inner-layer-side container mouth 223 of a thin cylindrical shape formed at an upper end of the container trunk 222. The container bottom 221 and the container trunk 222 are portions that have undergone biaxial stretch blow molding. The inner-layer-side container mouth 223 is a portion that has not undergone biaxial stretch blow molding.

As shown in FIG. 6(D), on an outer peripheral surface of the inner-layer-side container mouth 223, from an upper end side there are formed: a first outer peripheral surface 224; a second outer peripheral surface 225, located on the lower side of the first outer peripheral surface 224 and having a smaller diameter than the first outer peripheral surface 224; and a third outer peripheral surface 226, located on the lower side of the second outer peripheral surface 225 and having a larger diameter than the second outer peripheral surface 225. A lower end of the third outer peripheral surface 226 is connected to an outer peripheral surface of the container trunk 222. A mouth-side downward end face 227 of an annular shape is formed between the first outer peripheral surface 224 and the second outer peripheral surface 225. A mouth-side upward end face 228 of an annular shape is formed between the second outer peripheral surface 225 and the third outer peripheral surface 226.

A support ring 250 having a large diameter is integrally formed at a lower end of the cylindrical body 240. On an inner peripheral surface of the cylindrical body 240, from an upper opening end face 241 toward a lower opening end face 242 there are formed: a first inner peripheral surface 243; a second inner peripheral surface 244, located on the lower side of the first inner peripheral surface 243 and having a smaller diameter than the first inner peripheral surface 243; and a third inner peripheral surface 245, located on the lower side of the second inner peripheral surface 244 and having a larger diameter than the second inner peripheral surface 244. A tubular body-side upper end face 246 of an annular shape is formed between the first inner peripheral surface 243 and the second inner peripheral surface 244. A tubular body-side downward end face 247 of an annular shape is formed between the second inner peripheral surface 244 and the third inner peripheral surface 245. A male screw 248 for mounting a screw cap (not shown) is formed on an outer peripheral surface of the cylindrical body 240.

Here, at a lower end portion of the second inner peripheral surface 244 of the cylindrical body 240, an inward protrusion 249 is formed including a tapered inner peripheral surface 249a whose radially inward protrusion amount gradually increases downward. A lower end face of the inward protrusion 249 serves as the tubular body-side downward end face 247. In the present example, the third outer peripheral surface 226 on a lower end side of the inner-layer-side container mouth 223 serves as a tapered outer peripheral surface that gradually recedes radially inward as going downward.

In a state in which the cylindrical body 240 is attached to the inner-layer-side container mouth 223, the tubular body-side upward end face 246 of the cylindrical body 240 is engaged with (contacts) the mouth-side downward end face 227 of the inner-layer-side container mouth 223 from below. The tubular body-side downward end face 247 of the cylindrical body 240 contacts (is engaged with) the mouth-side upward end face 228 of the inner-layer-side container mouth 223 from above. By engagement of these portions in the up-down direction, the cylindrical body 4 is attached to the inner-layer-side container mouth 223 in a state of being positioned in the up-down direction. Falling-out of the cylindrical body 240 with respect to the inner-layer-side container mouth 223 in the up-down direction can also be prevented.

As shown in FIG. 6(C), on the first inner peripheral surface 243 of the cylindrical body 240, an inner peripheral flat surface 243c for rotation stopping is formed in two places in a diametrical direction. Similarly, on the first outer peripheral surface 224 of the inner-layer-side container mouth 223, an outer peripheral flat surface 224c for rotation stopping is formed having a complementary shape. By fitting the first outer peripheral surface 224 of the inner-layer-side container mouth 223 into the first inner peripheral surface 243 at the upper end of the cylindrical body 240, the cylindrical body 240 is attached to the inner-layer-side container mouth 223 in a coaxial state of being positioned in the circumferential direction, and misalignment of the cylindrical body 240 in the circumferential direction is also prevented.

In the state in which the cylindrical body 4 is attached to the inner-layer-side container mouth 223, a gap 270 for tag mounting is formed between the second inner peripheral surface 244 of the cylindrical body 240 and the second outer peripheral surface 225 of the inner-layer-side container mouth 223 that has a small diameter. The tag 260 is accommodated here. For example, the gap 270 is set to 0.1 mm to 5 mm. The same tag as the tag 6 of Embodiment 1 may be used for the tag 260.

### Example of Tagged Preform

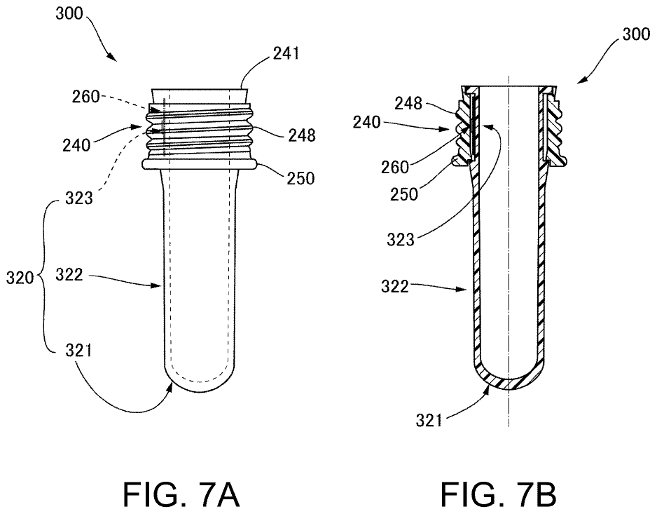

FIG. 7(A) is a side view of a tagged preform used in manufacturing the tagged container 200, and FIG. 7(B) is a longitudinal cross-sectional view of the tagged preform. A tagged preform 300 includes: a preform main body 320, which is an injection-molded product of thermoplastic resin; the cylindrical body 240, which is an injection-molded product of thermoplastic resin; and the tag 260.

The preform main body 320 includes a bottom 321, a trunk 322 of a cylindrical shape, and a mouth 323 of a cylindrical shape formed at an upper end of the trunk 322. The bottom 321 and the trunk 322 of the preform main body 320 are portions that undergo biaxial stretch blow molding and serve as the container bottom 221 and the container trunk 222 of the container main body 220. The mouth 323 of the preform main body 320 is a portion that directly serves as the inner-layer-side container mouth 223 of the container mouth of the container main body 220 without undergoing biaxial stretch blow molding. The mouth 323 has the same structure as the inner-layer-side container mouth 223. The cylindrical body 240 is a portion that directly serves as the outer-layer-side container mouth of the container mouth without undergoing biaxial stretch blow molding.

### Example of Manufacturing Procedure of Tagged Container

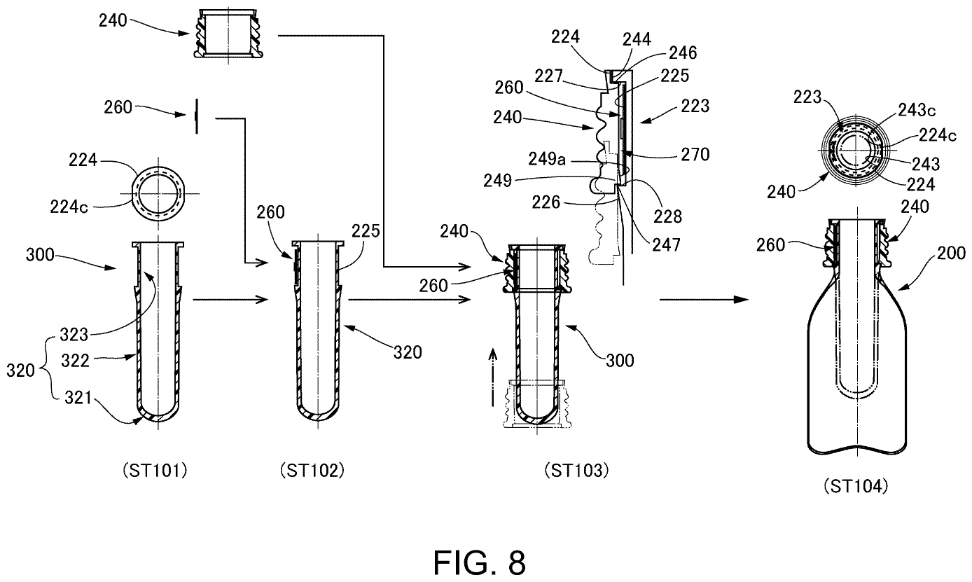

FIG. 8 is an explanatory diagram showing an overview of a manufacturing procedure of the tagged container 200. The preform main body 320 is prepared by injection molding using a thermoplastic resin material. Separately, the cylindrical body 240 that serves as the outer-layer-side container mouth is manufactured by injection molding using a thermoplastic resin material. The tag 260 is prepared (step ST101). The tag 260 is positioned and attached with an adhesive to the second outer peripheral surface 225 of the mouth 323 of the preform main body 320 (step ST102).

Next, the cylindrical body 240 is attached to the preform main body 320 (step ST103). The cylindrical body 240 is positioned in the circumferential direction so that both rotation stoppers (224c, 243c) coincide with each other. In this state, the preform main body 320 is coaxially inserted into the cylindrical body 240 from the bottom 321 side.

As described above, at the lower end portion of the second inner peripheral surface 244 of the cylindrical body 240, the inward protrusion 249 is formed including the tapered inner peripheral surface 249a whose radially inward protrusion amount gradually increases downward. The lower end face of the inward protrusion 249 serves as the tubular body-side downward end face 247. The third outer peripheral surface 226 on the lower end side of the inner-layer-side container mouth 223 serves as a tapered outer peripheral surface that gradually recedes radially inward as going downward. The second inner peripheral surface 244 of the cylindrical body 240 that has a small diameter is set to an inner diameter dimension that allows insertion of the preform main body 320 to therethrough from the bottom side.

When the preform main body 320 is inserted into the cylindrical body 240 from above, the third outer peripheral surface 226 (tapered outer peripheral surface) at a lower end of the mouth 323 contacts the tapered inner peripheral surface 249a of the inward protrusion 249 at the lower end of the cylindrical body 240. Since these surfaces have complementary tapered shapes, when the cylindrical body 240 is pushed with a predetermined force, the inward protrusion 249 of the cylindrical body 240 is guided along the third outer peripheral surface 226 being a tapered outer peripheral surface formed at the lower end of the mouth, climbs over the third outer peripheral surface 226 and is fitted into the upper side of the third outer peripheral surface 226. As a result, a state is achieved in which the inward protrusion 249 of the cylindrical body 240 contacts the mouth-side upward end face 228 of the mouth 323 from above. Meanwhile, a state is achieved in which the tubular body-side upward end face 246 of the cylindrical body 240 contacts the mouth-side downward end face 227 of the mouth 323 from below.

Accordingly, the cylindrical body 240 is positioned with respect to the inner-layer-side container mouth 223 in the up-down direction. Meanwhile, upward falling-out of the cylindrical body 240 is prevented. Furthermore, the rotation stopper (224c, 243c) that prevents rotation of the cylindrical body 240 with respect to the mouth 323 is formed between the first outer peripheral surface 224 of the mouth 323 and the first inner peripheral surface 243 of the cylindrical body 240. The cylindrical body 240 is also positioned in the circumferential direction, and its misalignment in the circumferential direction is also prevented. In this way, the tagged preform 300 is obtained including a mouth having a two-layer structure in which the tag 260 is arranged between the inner layer and the outer layer.

Next, the tagged preform 300 is heated to a temperature suitable for biaxial stretch blow molding. The tagged preform 300 after heating is placed into a blow molding mold (not shown), the mold is clamped, and biaxial stretch blow molding is performed (step ST104). That is, portions of the tagged preform 300 excluding the mouth 323 and the cylindrical body 240 are heated from the outside using a heater or the like. The tag 260 arranged between these portions is not exposed to high temperatures and does not suffer damage such as thermal deformation. In the tagged preform 300, the trunk 322 and the bottom 321 are portions having a single-layer structure. Thus, unlike the case where a preform having a two-layer or multi-layer structure is heated, each part of the bottom 321 and the trunk 322 is uniformly heated, and a temperature state suitable for blow molding is efficiently achieved.

The tagged preform 300 after heating is placed into the blow molding mold (not shown), the mold is clamped, and biaxial stretch blow molding is performed. Accordingly, the tagged preform 300 is molded into the tagged container 200. The cylindrical body 240 and the mouth 323 of the tagged preform 300 are portions held by a portion of the blow molding mold (not shown), and remain in their original shape without undergoing stretch blow molding. Accordingly, the tag 260 arranged between the cylindrical body 240 and the mouth 323 is not exposed to high-pressure air and is not stretched. Accordingly, in a blow molding process, no adverse effects such as damage or disconnection occur in the tag 260. In the tagged container 200 of the present example, similar effects to those of the tagged container 1 of Embodiment 1 are obtained.

### Other Embodiments

In the tagged containers 1 and 200 in which the container mouth has a layered structure including an inner-layer-side container mouth and an outer-layer-side container mouth, a top surface of the mouth is defined by a top surface of the inner-layer-side container mouths 23 and 223 and a top surface of the cylindrical bodies 4 and 240 (which are outer-layer-side container mouths). When a gap is formed at a joint portion of these top surfaces, there is a risk of foreign matter entering between an inner layer and an outer layer from the gap. To reliably prevent such adverse effects, a plug for sealing may be attached to the top surface of the mouth.

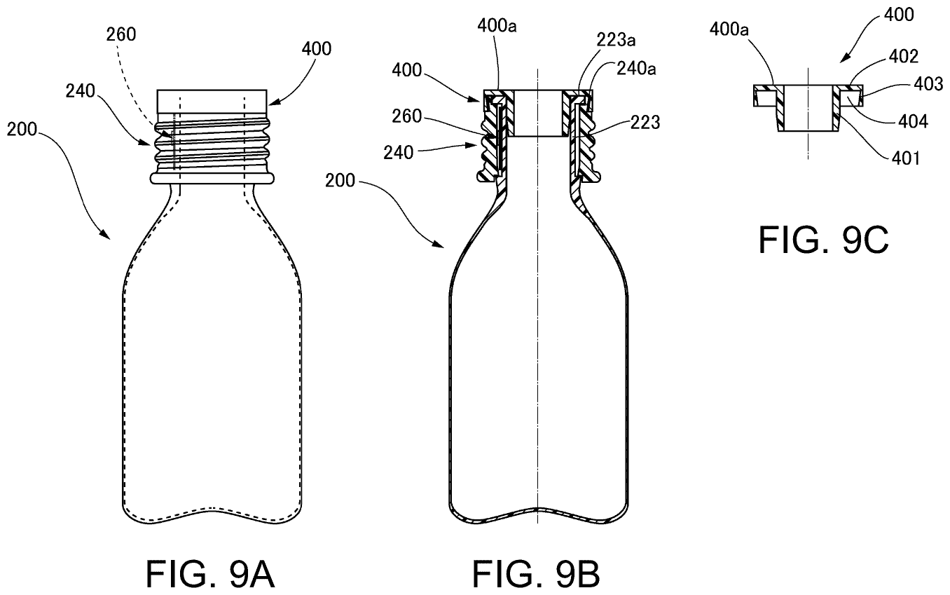

FIG. 9(A) is a side view showing an example in which a plug for sealing is attached to a top surface of the tagged container 200, FIG. 9(B) is a longitudinal cross-sectional view of the example, and FIG. 9(C) is a longitudinal cross-sectional view of the plug for sealing.

A plug 400 for sealing includes: an inner cylindrical part 401, fitted and fixed from above into an inside of the inner-layer-side container mouth 223 of the tagged container 200; an annular flange 402, extending outward from an upper end of the inner cylindrical part 401; and an outer annular part 403, protruding downward from an outer peripheral edge of the annular flange 402. A downward annular recess 404 is formed coaxially surrounding an outer periphery of the inner cylindrical part 401. A top surface portion of the container mouth of the tagged container 200 is fitted and fixed from below into the annular recess 404. Accordingly, an upper end of the tagged container 200 is sealed by the plug 400, and the top surface of the container mouth is defined by a top surface 400a of an annular shape of the plug 400. A joint surface between a top surface 240a of the cylindrical body 240 forming the outer-layer-side container mouth and a top surface 223a of the inner-layer-side container mouth 223 is sealed, and entry of foreign matter such as liquids from this joint surface is prevented.

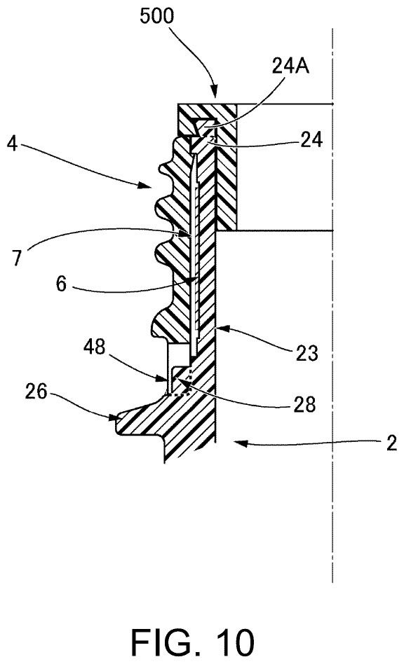

FIG. 10 is a half longitudinal cross-sectional view of a container mouth, showing an example in which a plug for sealing is attached to a top surface of the tagged container 1. An upper end face of the inner-layer-side mouth flange 24 formed at the upper end of the inner-layer-side container mouth 23 in the container main body 2 protrudes upward, and a plug attachment part 24A of an inverted truncated cone shape is formed. Here, a plug 500 for sealing is fitted and fixed from above. A joint surface between a top surface of the inner-layer-side container mouth 23 of the container main body 2 and the cylindrical body 4 is sealed by the plug 500, and entry of foreign matter such as liquids from the joint surface is prevented.

### DESCRIPTION OF REFERENCE NUMERALS

1: tagged container
2: container main body
4: cylindrical body
6: tag
7: tag arrangement gap
21: container bottom
22: container trunk
23: inner-layer-side container mouth
23b: inner peripheral surface
24: inner-layer-side mouth flange
24a: first outer peripheral surface
24b: mouth-side downward end face
25: inner-layer-side mouth cylindrical part
25a: second outer peripheral surface
25b: outer peripheral surface portion
25c: outer peripheral surface portion
25d: recess
26: support ring
26a: third outer peripheral surface
26b: mouth-side upward end face
28: engagement protrusion
41: outer peripheral surface
41a: male screw
42: inner peripheral surface
43: upper opening end face
44: first inner peripheral surface
45: second inner peripheral surface
46: lower opening end face
47: inward protrusion
47a: tapered arc surface
47b: tubular body-side upward end face
48: engagement groove
100: tagged preform
120: preform main body
121: bottom
122: trunk
123: mouth
200: tagged container
220: container main body
221: container bottom
222: container trunk
223: inner-layer-side container mouth
223a: top surface
224: first outer peripheral surface
224c: outer peripheral flat surface
225: second outer peripheral surface
226: third outer peripheral surface
227: mouth-side downward end face
228: mouth-side upward end face
240: cylindrical body
240a: top surface
241: upper opening end face
242: lower opening end face
243: first inner peripheral surface
243c: inner peripheral flat surface
244: second inner peripheral surface
245: third inner peripheral surface
246: tubular body-side upward end face
247: tubular body-side downward end face
248: male screw
249: inward protrusion
249a: tapered inner peripheral surface
250: support ring
260: tag
270: gap
300: tagged preform
320: preform main body
321: bottom
322: trunk
323: mouth
400, 500: plug
400a: top surface
401: inner cylindrical part
402: annular flange
403: outer annular part
404: annular recess
G: gap

To the claims:

1. A tagged preform, used in manufacturing a tagged container in which a container mouth has a layered structure comprising an inner-layer-side container mouth and an outer-layer-side container mouth, the tagged preform comprising:
a preform main body, made of synthetic resin and having a bottom, a trunk of a tubular shape, and a mouth of a tubular shape;
a tubular body, made of synthetic resin and fitted and fixed into an outer peripheral surface of the mouth in an up-down direction of the tagged preform; and
a tag, arranged between the outer peripheral surface of the mouth and an inner peripheral surface of the tubular body,
wherein
the bottom and the trunk are portions that undergo biaxial stretch blow molding and serve as a container bottom and a container trunk of the tagged container;
the mouth is a portion that directly forms the inner-layer-side container mouth without undergoing biaxial stretch blow molding; and
the tubular body is a portion that directly forms the outer-layer-side container mouth without undergoing biaxial stretch blow molding;
wherein
a first outer peripheral surface, a second outer peripheral surface, and a third outer peripheral surface are formed on an outer peripheral surface of the mouth, the second outer peripheral surface being located on a lower side of the first outer peripheral surface and having a smaller diameter than that of the first outer peripheral surface, the third outer peripheral surface being located on the lower side of the second outer peripheral surface and having a larger diameter than that of the second outer peripheral surface;
a mouth-side downward end face is formed between the first outer peripheral surface and the second outer peripheral surface, and a mouth-side upward end face is formed between the second outer peripheral surface and the third outer peripheral surface;
on the inner peripheral surface of the tubular body, a first inner peripheral surface and a second inner peripheral surface are formed between an upper end opening and a lower end opening of the tubular body, the second inner peripheral surface being located on the lower side of the first inner peripheral surface and opposed to the second outer peripheral surface with a predetermined gap;
a tubular body-side upward end face that is able to contact the mouth-side downward end face from below is formed between the first inner peripheral surface and the second inner peripheral surface, and a tubular body-side downward end face that is able to contact the mouth-side upward end face from above is formed at a lower end of the second inner peripheral surface;
the tubular body is fitted and fixed between the mouth-side downward end face and the mouth-side upward end face in a state of being positioned in the up-down direction with the tubular body-side upward end face contacting the mouth-side downward end face and the tubular body-side downward end face contacting the mouth-side upward end face; and
the tag is arranged in a gap formed between the second outer peripheral surface of the mouth and the second inner peripheral surface of the tubular body;
wherein
the mouth of the preform main body is insertable from the lower end opening of the tubular body;
an inward protrusion whose radially inward protrusion amount gradually increases upward is formed at an upper end portion of the second inner peripheral surface of the tubular body, an upper end face of the inward protrusion being the tubular body-side upward end face;
the inward protrusion of the tubular body is able to climb over the first outer peripheral surface from above the first outer peripheral surface and be fitted onto a side of the second outer peripheral surface; and
the inward protrusion is fitted onto the side of the second outer peripheral surface, and the tubular body-side upward end face at an upper end of the inward protrusion contacts the mouth-side downward end face from below,
or
wherein
the preform main body is inserted through the tubular body from the bottom side from the upper end opening of the tubular body to enable the mouth to be inserted into the tubular body;
an inward protrusion whose radially inward protrusion amount gradually increases downward is formed at a lower end portion of the second inner peripheral surface of the tubular body, a lower end face of the inward protrusion being the tubular body-side downward end face;
the inward protrusion of the tubular body is able to climb over the third outer peripheral surface from below the third outer peripheral surface and be fitted onto a side of the second outer peripheral surface; and
the inward protrusion is fitted onto the side of the second outer peripheral surface, and the tubular body-side downward end face of the inward protrusion contacts the mouth-side upward end face from above.

2. (canceled)

3. (canceled)

4. (canceled)

5. The tagged preform according to claim 1, further comprising:
a rotation stopper, configured to prevent rotation of the tubular body with respect to the mouth.

6. The tagged preform according to claim 1, further comprising:
a rotation stopper, configured to prevent rotation of the tubular body with respect to the mouth,
wherein
the rotation stopper comprises:
an engagement groove, formed in the tubular body, opening at the tubular body-side downward end face, and penetrating the tubular body in a radial direction; and
an engagement protrusion, formed on the mouth, protruding upward from the mouth-side upward end face, and fitted into the engagement groove from below,
wherein
between an upper surface of the engagement protrusion fitted into the engagement groove and a groove inner peripheral surface of the engagement groove opposed to the engagement protrusion from above, a gap is formed so that a force is able to be applied to disengage an engaged portion between the tubular body-side upward end face of the inward protrusion of the tubular body and the mouth-side downward end face of the mouth; and
the engaged portion has an anti-counterfeiting function that prevents re-engagement after disengagement.

7. The tagged preform according to claim 1, wherein
the tag is an information carrying tag comprising a circuit pattern having an antenna and an IC chip, wherein
the information carrying tag is:
a tag attached to the outer peripheral surface of the mouth or the inner peripheral surface of the tubular body, or
a tag having the circuit pattern formed on the outer peripheral surface or the inner peripheral surface and the IC chip mounted on the circuit pattern.

8. The tagged preform according to claim 1, wherein
a tag arrangement gap where the tag is arranged is formed between the outer peripheral surface of the mouth and the inner peripheral surface of the tubular body; and
the tag arrangement gap has a dimension of 0.1 mm to 5 mm.

9. The tagged preform according to claim 1, further comprising:
a plug for sealing, configured to seal a joint surface between an upper end face of the mouth and an upper end face of the tubular body.

10. A tagged container, manufactured by biaxial stretch blow molding of the tagged preform according to claim 1, comprising:
a container bottom, a container trunk of a tubular shape, and a container mouth of a tubular shape, wherein
the container mouth has a layered structure comprising an inner-layer-side container mouth and an outer-layer-side container mouth;
the container bottom and the container trunk are portions obtained by biaxial stretch blow molding of the bottom and the trunk of the preform main body;
the inner-layer-side container mouth is a portion where the mouth of the preform main body remains unchanged without undergoing biaxial stretch blow molding;
the outer-layer-side container mouth is a portion where the tubular body remains unchanged without undergoing biaxial stretch blow molding; and
the tag is arranged between the inner-layer-side container mouth and the outer-layer-side container mouth.

11. (canceled)

12. (canceled)

13. (canceled)

14. The tagged container according to claim 10, further comprising:
a rotation stopper, configured to prevent rotation of the tubular body with respect to the inner-layer-side container mouth.

15. The tagged container according to claim 10, further comprising:
a rotation stopper, configured to prevent rotation of the tubular body with respect to the inner-layer-side container mouth,
wherein
the rotation stopper comprises:
an engagement groove, formed in the tubular body, opening at the tubular body-side downward end face, and penetrating the tubular body in the radial direction; and
an engagement protrusion, formed on the inner-layer-side container mouth, protruding upward from the mouth-side upward end face, and fitted into the engagement groove from below,
wherein
between an upper surface of the engagement protrusion fitted into the engagement groove and a groove inner peripheral surface of the engagement groove opposed to the engagement protrusion from above, a gap is formed so that a force is able to be applied to disengage an engaged portion between the tubular body-side upward end face of the inward protrusion of the tubular body and the mouth-side downward end face of the container mouth; and
the engaged portion has an anti-counterfeiting function that prevents re-engagement after disengagement.

16. The tagged container according to claim 10, wherein
the tag is an information carrying tag comprising a circuit pattern having an antenna and an IC chip, wherein
the information carrying tag is:
a tag attached to the outer peripheral surface or the inner peripheral surface, or
a tag having the circuit pattern formed on the outer peripheral surface or the inner peripheral surface and the IC chip mounted on the circuit pattern.

17. The tagged container according to claim 10, wherein
a tag arrangement gap where the tag is arranged is formed between the outer peripheral surface of the inner-layer-side container mouth and the inner peripheral surface of the tubular body; and
the tag arrangement gap has a dimension of 0.1 mm to 5 mm.

18. The tagged container according to claim 10, further comprising:
a plug for sealing, configured to seal a joint surface between an upper end face of the inner-layer-side container mouth and an upper end face of the tubular body.
